(19) United States
(12) Patent Application Publication
(10) Pub. No.: US 2007/0078894 A1
(43) Pub. Date: Apr. 5, 2007

(54) System and method for unified SKU (stock keeping unit) enablement

(76) Inventors: Michael A. Rothman, Puyallup, WA (US); Vincent J. Zimmer, Federal Way, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/241,181

(22) Filed: Sep. 30, 2005

(51) Int. Cl. G06F 17/00

(52) U.S. Cl. 707/104.1

(57) ABSTRACT

A system, method, and article of manufacture for unified SKU (Stock Keeping Unit) enablement. The system includes a computer platform having a FLASH device. The FLASH device including an area reserved for a firmware image. The firmware image being of a single SKU and having a default language string. The firmware image also including language string content to display to an end user after an initial power-on. The language string content to enable the end user to select a language for the firmware image. The system also includes a web server coupled to the computer platform via a network, wherein if the selected language differs from the default language string of the firmware image, the computer platform to communicate with the web server over the network to retrieve a language string package for the selected language.

### BACKGROUND OF THE INVENTION

1. Field of the Invention

The present invention is generally related to unified SKU (Stock Keeping Unit) enablement for computer platforms. More particularly, the present invention is related to a system and method for providing computer platforms with a full complement of international language support on a single SKU.

2. Description

Computer platforms are sold world-wide. Today, common embodiments of computer platforms have a variety of SKUs (Stock Keeping Units) that are made with different preloaded firmware images based on an intended shipping geography. For instance, computer platforms sold primarily in Germany might only have room for three languages and the languages in question may be German, French, and English. Computer platforms sold in Spain will have a different SKU, and may have embedded language support for English, Spanish, and Italian. The added variability and pre-loaded image choices end up making the support and maintenance of these varied SKUs more expensive and complex.

Many of the geographies in which computers are shipped have a need for very low-cost computer platforms. A problem that exists with very low-cost computer platforms is that they have a limited size flash memory, and therefore, may not be able to provide multiple language translations in their firmware's flash part due to limited flash size and price constraints. The added overhead associated with the storage of the multiple translations increases the cost of the flash and causes a maintenance burden that the geographic area may be unwilling to bear.

The firmware used in the computer platforms often times includes text that gets communicated to the end-user. The text may be in the form of language strings, such as, but not limited to, English language strings. When language strings implemented on a computer platform are not practical for the population that is purchasing the computer platform, the end-user may not be able to read or comprehend the meaning of the language strings.

Thus, what is needed is a system and method for providing computer platforms with a full complement of international language support on a single SKU without burdening the computer platform with undue FLASH size and cost. What is also needed is a system and method for providing computer platforms with a full complement of international language support on a single SKU without requiring complex and expensive support and maintenance.

### BRIEF DESCRIPTION OF THE DRAWINGS

The accompanying drawings, which are incorporated herein and form part of the specification, illustrate embodiments of the present invention and, together with the description, further serve to explain the principles of the invention and to enable a person skilled in the pertinent art(s) to make and use the invention. In the drawings, like reference numbers generally indicate identical, functionally similar, and/or structurally similar elements. The drawing in which an element first appears is indicated by the leftmost digit(s) in the corresponding reference number.

FIG. 1 is a block diagram illustrating an exemplary system for providing computer platforms with a full complement of international language support on a single SKU according to an embodiment of the present invention.

FIG. 2 is a screen shot illustrating exemplary language string content for enabling an end-user to select a language for implementation on a computer platform according to an embodiment of the present invention.

FIG. 3 is a flow diagram describing an exemplary method for providing computer platforms with a full complement of international language support on a single SKU according to an embodiment of the present invention.

FIG. 4 is a flow diagram describing an exemplary method for subsequent rebooting of computer platforms having a desired language string package stored on a local non-volatile storage unit other than a FLASH device according to an embodiment of the present invention.

FIG. 5 is a block diagram illustrating an exemplary computer system in which certain aspects of the invention may be implemented.

### DETAILED DESCRIPTION OF THE INVENTION

While the present invention is described herein with reference to illustrative embodiments for particular applications, it should be understood that the invention is not limited thereto. Those skilled in the relevant art(s) with access to the teachings provided herein will recognize additional modifications, applications, and embodiments within the scope thereof and additional fields in which embodiments of the present invention would be of significant utility.

Reference in the specification to “one embodiment”, “an embodiment” or “another embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

Embodiments of the present invention are directed to a system and method for providing computer platforms with a full complement of international language support on a single SKU (Stock Keeping Unit). This is accomplished using the computer platform's existing FLASH capacity and the ability for the computer platform to communicate with a Web server over a network connection. Computer platforms are manufactured using a unified SKU and shipped to designate geographic areas. The unified SKU includes a default language string package, such as, for example, an English language string package. When the computer system is powered up by the end-user for the first time, the end-user may be provided with a plurality of language strings for enabling the end-user to choose a language string that is recognizable by the end-user (that is, the language string in the end-user's native language). In alternative embodiments, the end-user may be queried by requesting the end-user to enter the language of his/her choice to be used. If the language selected or requested by the end-user is not the language that is implemented in the language string package on the FLASH device, the computer system may connect to a Web server to retrieve the language string package selected or requested by the end-user. If the FLASH device has the capacity to store the retrieved language string package, the default language string package may be replaced with the retrieved language string package. Subsequent logging-on by the end-user will result in the computer system automatically utilizing the retrieved language string package.

If the FLASH device does not have the capacity to store the retrieved language string package, the retrieved language string package may be stored on a local non-volatile storage device other than the FLASH, if one exists. A language variable is stored to enable subsequent logging-on of the computer system to utilize the language string package stored on the local non-volatile storage device, not the FLASH (since the default language string package still resides on the FLASH).

By providing the ability to support multiple languages in a dynamic fashion without requiring the underlying infrastructure to have a larger FLASH, the end-user may be presented with text in their native language with no added cost. By providing a unified SKU of a firmware image for computer platforms, one can avoid the complexities associated with managing and supporting multiple firmware images and the needed support for such deployments. Also, employing embodiments of the present invention enables motherboards to now be resold in a myriad of geographic locations without having to re-spin the BIOS (Basic Input/Output System) for adding or changing translations.

Embodiments of the present invention are described as having the language string package pre-loaded on a magnetic media, such as in the firmware reserved area. The invention is not limited to having the language string package pre-loaded on the magnetic media. In alternative embodiments, the language string package may be provided as a resource available on the Internet which the end-user may download. One skilled in the relevant art(s) would know that storage means other than the firmware reserved area, such as, but not limited to, other non-volatile storage media means, are equally applicable.

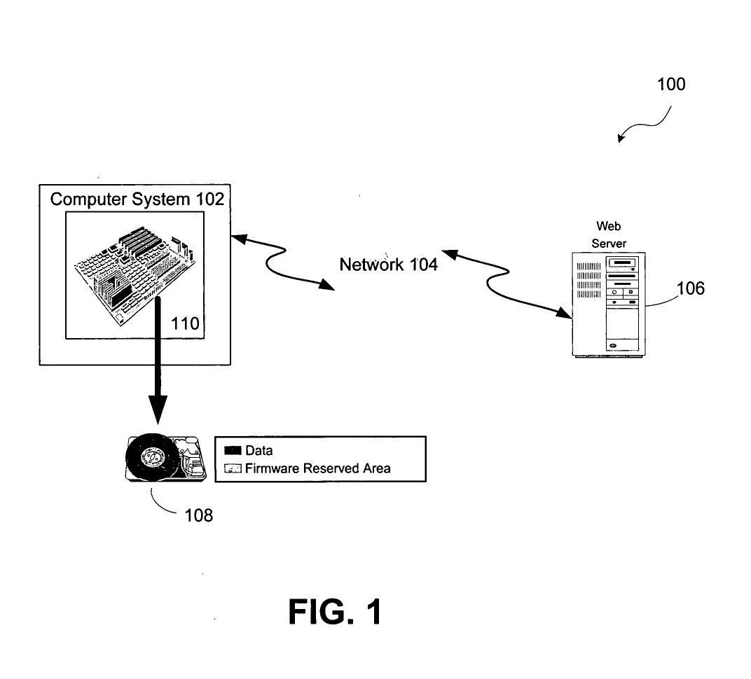

FIG. 1 is a block diagram illustrating an exemplary system 100 for providing computer platforms with a full complement of international language support on a single SKU according to an embodiment of the present invention. System 100 comprises a computer system 102, a network 104, and a Web server 106. Computer system 102 and Web server 106 are coupled to network 104 via network connections using network interface cards (not shown) in a well known manner. The network connection may be a wired connection or a wireless connection.

Computer system 102 includes, inter alia, a computer platform 110 having a FLASH device 108. FLASH device 108 comprises a firmware reserved area for a firmware image and an area for data. The firmware image being of a single SKU (Stock Keeping Unit) comprising a default language string package.

The default language string package is capable of being replaced with a language string package selected by an end-user of computer 102. The ability of computer platform 110 to enable an end-user to select a language string package from a myriad of international language string packages as a replacement for the default language string package without requiring a larger FLASH component keeps costs low and avoids the complexities associated with managing multiple firmware images.

When an end-user logs-on to computer system 102 for the first time, the end-user is queried as to what language the end-user would prefer to be used by the firmware. This query may be in the form of a question in which the end-user is prompted, such as, for example, “What is your native language?” In one embodiment, the query is in the form of language string content comprising a language string that is listed in a myriad of different languages. In this instance, the end-user may select the language string of their choice. Computer platform 110 will then compare the end-user's selection with the default language string package on the FLASH. If they are not the same, computer platform 110 will retrieve the selected language string package for the selected language from an outside source, such as, for example, Web server 106 via network 104. After retrieving the selected language string package, computer platform 110 will replace the default language string package on FLASH 108 with the retrieved language string package, if FLASH 108 has enough free space to hold the retrieved language string package. If FLASH 108 does not have enough free space and free space is available on another non-volatile memory device on computer platform 110, then the retrieved language string package may be stored on the non-volatile memory device. Otherwise, the end-user may have to queried each time the end-user logs onto computer system 102.

As previously stated, embodiments of the present invention may provide the end-user with queries to enable the end-user to provide the system with the end-user's native language or a language of the end-user's choice. Embodiments of the present invention may also provide the end-user with retrieved language string content that comprises a language string in a plurality of different languages for enabling the end-user to select the language of their choice.

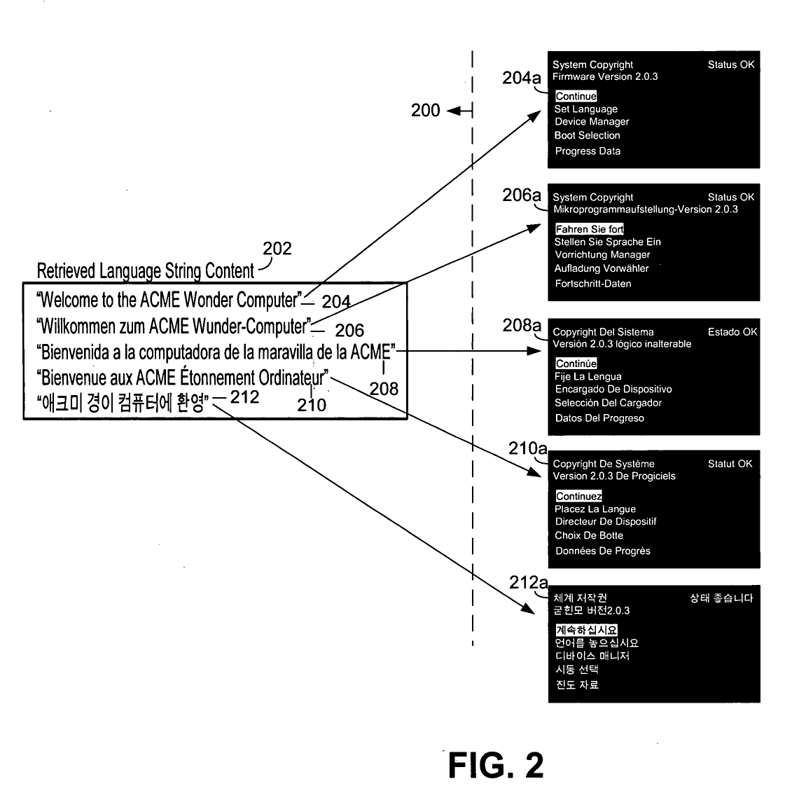

FIG. 2 is a screen shot illustrating exemplary language string content 202 for enabling an end-user to select a language for implementation on a computer platform according to an embodiment of the present invention. The example language string content shown in FIG. 2 shows five different languages from which an end-user may select their native language or a language of their choice. The languages represented include a language string in English 204, a language string in German 206, a language string in Spanish 208, a language string in French 210, and a language string in Korean 212. If the end-user selects English language string 204, exemplary firmware status text may be presented to the user as shown in 204a. If the end-user selects German language string 206, exemplary firmware status text may be presented to the user as shown in 206a. If the end-user selects Spanish language string 208, exemplary firmware status text may be presented to the user as shown in 208a. If the end-user selects French language string 210, exemplary firmware status text may be presented to the user as shown in 210a. If the end-user selects Korean language string 212, exemplary firmware status text may be presented to the user as shown in 212a. One skilled in the relevant arts will know that additional, as well as different, languages may be used when presenting language strings to the end-user to enable the end-user to select their native language or a language of their choice. The language string content presented to the user may be retrieved from a local non-volatile storage or from another source over a network connection, such as, but not limited to, a Web server.

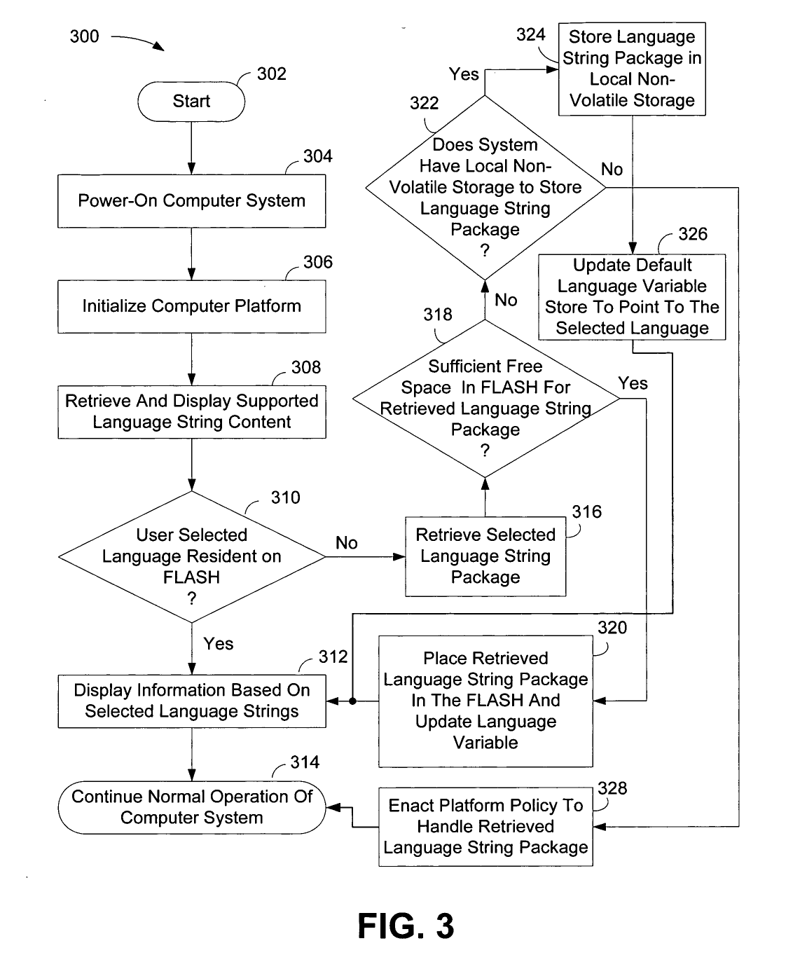

FIG. 3 is a flow diagram 300 describing an exemplary method for providing computer platforms with a full complement of international language support on a single SKU according to an embodiment of the present invention. The invention is not limited to the embodiment described herein with respect to flow diagram 300. Rather, it will be apparent to persons skilled in the relevant art(s) after reading the teachings provided herein that other functional flow diagrams are within the scope of the invention. The process begins with block 302, where the process immediately proceeds to block 304.

In block 304, the computer system is powered on. Immediately after powering-on the computer system, the computer platform is initialized in block 306.

In block 308, a screen comprising the supported language strings, such as, for example, the exemplary screen 200 shown in FIG. 2, is provided to the end-user to enable the end-user to select a language of the end-user's choice. In one embodiment, the supported language strings are retrieved from the firmware reserved area on hard-drive 108 of computer system 102 for display to the end-user. In another embodiment, the supported strings may be retrieved from a server website for display to the end-user, such as, for example, the server website of the OEM (Original Equipment Manufacturer), via a network connection. Once the screen is displayed, the end-user may select a language string from the supported language strings of which the user is most familiar. For example, if the user is English, the user may select the first language string shown in FIG. 2. If the user is German, the user may select the second language string shown in FIG. 2, etc. The process then proceeds to decision block 310.

In decision block 310, it is determined whether the end-user selected the language resident on the FLASH. If the end-user selected the resident language, the process proceeds to block 312.

In block 312, information is displayed on the computer system based on the end-user's selected language string. The process then proceeds to block 314, where normal operations for the computer system may continue.

Returning to decision block 310, if it is determined that the end-user selected a language that is not resident in the FLASH, then the process proceeds to block 316.

In block 316, a language string package based on the selected language is retrieved from a non-volatile store. The non-volatile store may be a local non-volatile storage device or it may be a remote non-volatile storage device. For example, if the selected language is French, the system may retrieve the French string package from a local hard drive if the French string package is stored on the local hard drive. If the French string package is not stored on the local hard drive, the system may retrieve the French string package from a remote source, such as, but not limited to, a Web server. Once the selected language string package has been retrieved, the process proceeds to decision block 318.

In decision block 318, it is determined whether there is sufficient free space in the FLASH for the retrieved language string package. If it is determined that there is sufficient free space in the FLASH for the retrieved selected language string package, then the process proceeds to block 320.

In block 320, the retrieved language string package is placed in the FLASH and the language variable is updated with the user selected language. In one embodiment, the default language string package that was initially installed on the FLASH is replaced by the retrieved language string package. The process then proceeds to block 312.

In block 312, information is displayed based on the selected language string package. The process then proceeds to block 314, where normal operations for the computer system may continue.

Returning to decision block 318, if it is determined that the FLASH does not have sufficient free space to store the retrieved language string package, then the process proceeds to decision block 322. In decision block 322, it is determined whether the system has a local non-volatile storage device for storing the retrieved language string package. If the system has a local non-volatile storage device for storing the retrieved language string package, then the process proceeds to block 324.

In block 324, the retrieved language string package is stored in the local non-volatile storage. The process then proceeds to block 326.

In block 326, a default language variable store is updated to point to the selected language. The process then proceeds to block 312.

In block 312, information is displayed based on the selected language string package. The process then proceeds to block 314, where normal operations for the computer system may continue.

Returning to decision block 322, if it is determined that the system does not have a local non-volatile storage device for storing the retrieved language string package, then the process proceeds to block 328. In block 328, computer platform policy is enacted to handle the retrieved language string package. The computer platform policy may be based on requirements determined by the OEM. In this case, a plurality of solutions may be implemented, all of which may vary depending upon the specific OEM. For example, the computer system may proceed with displaying the selected language string package while the system is currently being used, but when the system is shut down, the selected language string package will be lost. However, policy may dictate that the end-user be queried each time the end-user logs-on to the computer system to determine which language string package to use. The system will then retrieve the language string package selected by the end-user from the Web server of the OEM.

In another example, policy may dictate that a language variable be saved indicating what language the end-user selected. When the computer system is rebooted, the system may retrieve the language variable and compare it with the language string package stored in the FLASH. If the language variable is different from the language string package stored in the FLASH, the system may retrieve the selected language string package from the OEM Web server.

In yet another example, policy may dictate that the language variable be saved. When the computer system is rebooted, the system will retrieve the language variable and search for the language string package associated with the language variable. If the language string package cannot be found on the computer system, then the system may retrieve the language string package from the OEM Web server.

Policy may also dictate that since downloading the language string package takes several seconds, it may not be desirable to download the desired language string package every time the end-user logs onto the system. In this instance, the end-user may be stuck with using the default language string package.

Once policy has been enacted, the process will proceed from block 328 to block 314, where normal operations for the computer system may continue.

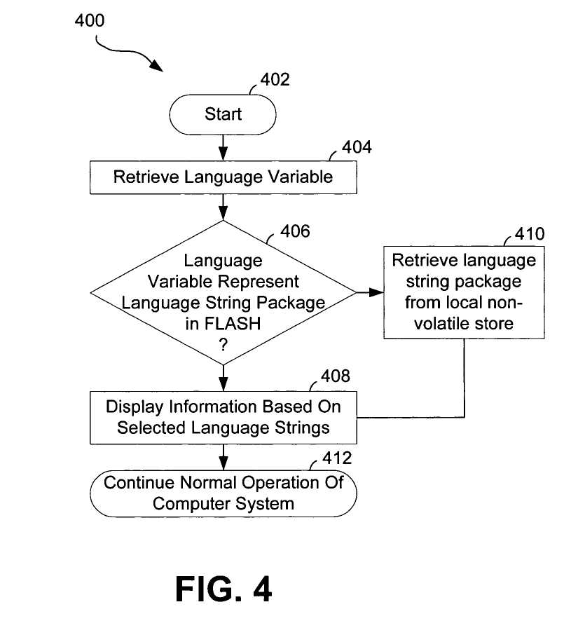

FIG. 4 is a flow diagram 400 describing an exemplary method for subsequent rebooting of computer platforms having a desired language string package stored on a local non-volatile storage unit other than a FLASH device according to an embodiment of the present invention. The invention is not limited to the embodiment described herein with respect to flow diagram 400. Rather, it will be apparent to persons skilled in the relevant art(s) after reading the teachings provided herein that other functional flow diagrams are within the scope of the invention. The process begins with block 402, where the process immediately proceeds to block 404.

In block 404, after an end-user has powered-up computer system 102 and computer system 102 has been initialized, the language variable is retrieved. As previously stated, the language variable contains the language that the end-user identified during a previous operating session of computer system 102. The process then proceeds to decision block 406.

In decision block 406, it is determined whether the language variable is representative of the language in the language string package stored in FLASH 108. If the language variable is representative of the language string package stored in FLASH 108, the process proceeds to block 408.

In block 408, information is displayed on the computer system based on the end-user's selected language string. The process then proceeds to block 412, where normal operations for computer system 102 may continue using the language string package stored in FLASH 108.

Returning to decision block 406, if it is determined that the language variable is not representative of the language in the language string package stored in FLASH 108, then the process proceeds to block 410. In block 410, computer system 102 retrieves the language string package representative of the language variable from the local non-volatile memory device of computer system 102. The process then proceeds to block 408 where information is displayed based on the retrieved language string package. The process then proceeds to block 412, where normal operations for computer system 102 may continue using the language string package retrieved from the local non-volatile memory device.

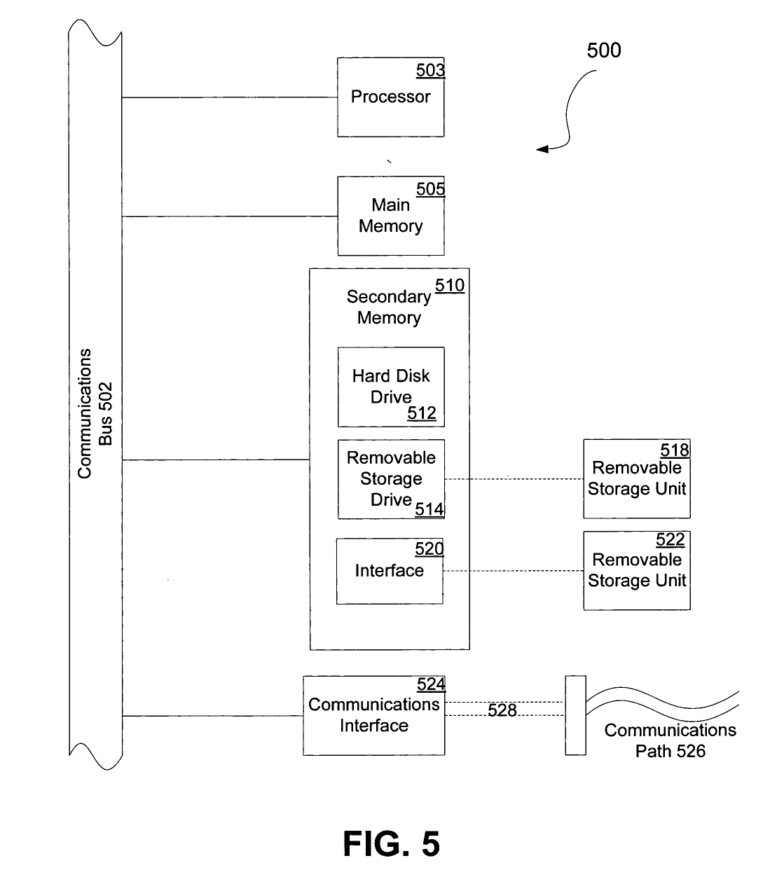

Embodiments of the present invention may be implemented using hardware, software, or a combination thereof and may be implemented in one or more computer systems or other processing systems. In fact, in one embodiment, the invention is directed toward one or more computer systems capable of carrying out the functionality described here. An example implementation of a computer system 500 is shown in FIG. 5. Various embodiments are described in terms of this exemplary computer system 500. After reading this description, it will be apparent to a person skilled in the relevant art how to implement the invention using other computer systems and/or computer architectures.

Computer system 500 includes one or more processors, such as processor 503. Processor 503 is connected to a communication bus 502. Computer system 500 also includes a main memory 505, preferably random access memory (RAM) or a derivative thereof (such as SRAM, DRAM, etc.), and may also include a secondary memory 510. Secondary memory 510 may include, for example, a hard disk drive 512 and/or a removable storage drive 514, representing a floppy disk drive, a magnetic tape drive, an optical disk drive, etc. Removable storage drive 514 reads from and/or writes to a removable storage unit 518 in a well-known manner. Removable storage unit 518 represents a floppy disk, magnetic tape, optical disk, etc., which is read by and written to by removable storage drive 514. As will be appreciated, removable storage unit 518 includes a computer usable storage medium having stored therein computer software and/or data.

In alternative embodiments, secondary memory 510 may include other similar means for allowing computer programs or other instructions to be loaded into computer system 500. Such means may include, for example, a removable storage unit 522 and an interface 520. Examples of such may include a program cartridge and cartridge interface (such as that found in video game devices), a removable memory chip (such as an EPROM (erasable programmable read-only memory), PROM (programmable read-only memory), or flash memory) and associated socket, and other removable storage units 522 and interfaces 520 which allow software and data to be transferred from removable storage unit 522 to computer system 500.

Computer system 500 may also include a communications interface 524. Communications interface 524 allows software and data to be transferred between computer system 500 and external devices. Examples of communications interface 524 may include a modem, a network interface (such as an Ethernet card), a communications port, a PCMCIA (personal computer memory card international association) slot and card, a wireless LAN (local area network) interface, etc. In one embodiment, communications interface 524 may be a network interface controller (NIC). Software and data transferred via communications interface 524 are in the form of signals 528 which may be electronic, electromagnetic, optical or other signals capable of being received by communications interface 524. These signals 528 are provided to communications interface 524 via a communications path (i.e., channel) 526. Channel 526 carries signals 528 and may be implemented using wire or cable, fiber optics, a phone line, a cellular phone link, a wireless link, and other communications channels.

In this document, the term “computer program product” refers to removable storage units 518, 522, and signals 528. These computer program products are means for providing software to computer system 500. Embodiments of the invention are directed to such computer program products.

Computer programs (also called computer control logic) are stored in main memory 505, and/or secondary memory 510 and/or in computer program products. Computer programs may also be received via communications interface 524. Such computer programs, when executed, enable computer system 500 to perform the features of the present invention as discussed herein. In particular, the computer programs, when executed, enable processor 503 to perform the features of embodiments of the present invention. Accordingly, such computer programs represent controllers of computer system 500.

In an embodiment where the invention is implemented using software, the software may be stored in a computer program product and loaded into computer system 500 using removable storage drive 514, hard drive 512 or communications interface 524. The control logic (software), when executed by processor 503, causes processor 503 to perform the functions of the invention as described herein.

In another embodiment, the invention is implemented primarily in hardware using, for example, hardware components such as application specific integrated circuits (ASICs). Implementation of hardware state machine(s) so as to perform the functions described herein will be apparent to persons skilled in the relevant art(s). In yet another embodiment, the invention is implemented using a combination of both hardware and software.

While various embodiments of the present invention have been described above, it should be understood that they have been presented by way of example only, and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined in accordance with the following claims and their equivalents.

What is claimed is:

1. A system for unified SKU (Stock Keeping Unit) enablement, comprising:
a computer platform having a FLASH device, the FLASH device including an area reserved for a firmware image, the firmware image being of a single SKU having a default language string, the firmware image also including language string content to display to an end user after an initial power-on, the language string content to enable the end user to select a language for the firmware image; and
a web server coupled to the computer platform via a network,
wherein if the selected language differs from the default language string of the firmware image, the computer platform to communicate with the web server over the network to retrieve a language string package for the selected language.

2. The system of claim 1, wherein if the selected language differs from the default language string, the computer platform to further replace the default language string on the FLASH with the retrieved language string package to enable subsequent use of the computer platform to operate using the retrieved language string packet.

3. The system of claim 1, further comprising a non-volatile storage device to store the retrieved language string package if free space on the FLASH is inadequate to store the retrieved language string package.

4. The system of claim 1, wherein the language string content comprises a language string repeated in a myriad of international languages, wherein the end user to select the language string written in the international language of the end-user's choosing.

5. A method for unified SKU (Stock Keeping Unit) enablement, comprising:
displaying supported language strings to an end-user to enable the end-user to select a language of the end-user's choice immediately after a computer platform is initialized;
determining whether the end-user selected a language that is resident on a firmware image stored on a FLASH device;
if the end-user did not select the resident language, then
retrieving a language string package for the selected language from a non-volatile store;
determining whether sufficient free space exists to replace the resident language on the FLASH device with the retrieved language string package; and
if the sufficient free space exists, replacing the resident language on the FLASH with the retrieved language string package.

6. The method of claim 5, wherein if the retrieved language string is stored in the FLASH device, the method further comprising:
updating a language variable with the end-user selected language;
displaying information on the computer platform based on the selected language string package; and
continuing normal operations of the computer platform using the selected language string package.

7. The method of claim 5, wherein if the FLASH device does not have sufficient free space, the method further comprising:
determining whether the computer platform has a local non-volatile storage device other than the FLASH device;
if a local non-volatile storage device other than the FLASH device exists, then
storing the retrieved language string package in the local non-volatile storage device;
updating a default language variable store to point to the selected language in the non-volatile storage device;
displaying information on the computer platform based on the selected language string package; and
continuing normal operations of the computer platform using the selected language string package.

8. The method of claim 7, wherein if a local non-volatile storage device other than the FLASH device does not exist, the method further comprising:
enacting policy to handle the retrieved language string package; and
continuing normal operations of the computer platform using the selected language string package.

9. The method of claim 8, wherein the policy comprises policy based on requirements of an OEM (Original Equipment Manufacturer).

10. The method of claim 5, wherein if the end-user selected a language that is resident on the firmware image stored on the FLASH device, the method further comprising:
displaying information on the computer platform based on the language resident on the firmware image; and
continuing normal operations of the computer platform based on the language resident on the firmware image.

11. The method of claim 5, wherein retrieving a language string package from a non-volatile store further comprises retrieving the language string package from a remote non-volatile store, the remote non-volatile store comprising a web server.

12. The method of claim 11, wherein the web server comprises an OEM (Original Equipment Manufacturer) web server.

13. The method of claim 5, wherein retrieving a language string package from a non-volatile store further comprises retrieving the language string package from a local non-volatile store, the local non-volatile store comprising a hard drive.

14. The method of claim 5, wherein the supported language strings are retrieved from the firmware image stored on the FLASH device.

15. The method of claim 5, wherein the supported language strings are retrieved from a server website over a network connection.

16. An article comprising: a storage medium having a plurality of machine accessible instructions, wherein when the instructions are executed by a processor, the instructions provide for displaying supported language strings to an end-user to enable the end-user to select a language of the end-user's choice immediately after a computer platform is initialized;
determining whether the end-user selected a language that is resident on a firmware image stored on a FLASH device;
if the end-user did not select the resident language, then
retrieving a language string package for the selected language from a non-volatile store;
determining whether sufficient free space exists to replace the resident language on the FLASH device with the retrieved language string package; and
if the sufficient free space exists, replacing the resident language on the FLASH with the retrieved language string package.

17. The article of claim 16, wherein if the retrieved language string is stored in the FLASH device, the article further comprising instructions for:
updating a language variable with the end-user selected language;
displaying information on the computer platform based on the selected language string package; and
continuing normal operations of the computer platform using the selected language string package.

18. The article of claim 16, wherein if the FLASH device does not have sufficient free space, the article further comprising instructions for:
determining whether the computer platform has a local non-volatile storage device other than the FLASH device;
if a local non-volatile storage device other than the FLASH device exists, then
storing the retrieved language string package in the local non-volatile storage device;
updating a default language variable store to point to the selected language in the non-volatile storage device;
displaying information on the computer platform based on the selected language string package; and
continuing normal operations of the computer platform using the selected language string package.

19. The article of claim 18, wherein if a local non-volatile storage device other than the FLASH device does not exist, the article further comprising instructions for:
enacting policy to handle the retrieved language string package; and
continuing normal operations of the computer platform using the selected language string package.

20. The article of claim 19, wherein the policy comprises policy based on requirements of an OEM (Original Equipment Manufacturer).

21. The article of claim 16, wherein if the end-user selected a language that is resident on the firmware image stored on the FLASH device, the article further comprising instructions for:
displaying information on the computer platform based on the language resident on the firmware image; and
continuing normal operations of the computer platform based on the language resident on the firmware image.

22. The article of claim 16, wherein retrieving a language string package from a non-volatile store further comprises instructions for retrieving the language string package from a remote non-volatile store, the remote non-volatile store comprising a web server.

23. The article of claim 22, wherein the web server comprises an OEM (Original Equipment Manufacturer) web server.

24. The article of claim 16, wherein retrieving a language string package from a non-volatile store further comprises instructions for retrieving the language string package from a local non-volatile store, the local non-volatile store comprising a hard drive.

25. The article of claim 16, wherein the supported language strings are retrieved from the firmware image stored on the FLASH device.

26. The article of claim 16, wherein the supported language strings are retrieved from a server website over a network connection.
